(19) United States
(12) Patent Application Publication
(10) Pub. No.: US 2024/0372122 A1
(43) Pub. Date: Nov. 7, 2024

(54) SOLID OXIDE FUEL CELL AND MANUFACTURING METHOD OF THE SAME

(71) Applicant: TAIYO YUDEN CO., LTD., Tokyo (JP)

(72) Inventor: Xinyu LI, Tokyo (JP)

(73) Assignee: TAIYO YUDEN CO., LTD., Tokyo (JP)

(21) Appl. No.: 18/263,863

(22) PCT Filed: Jan. 12, 2022
(86) PCT No.: PCT/JP2022/000759

§ 371 Date: Jul. 9, 2024

(30) Foreign Application Priority Data
Mar. 19, 2021 (JP) 2021-046531

(51) Int. Cl. H01M 8/1246; H01M 4/86; H01M 4/88; H01M 4/90

(52) U.S. Cl. CPC H01M 8/1246; H01M 4/8621; H01M 4/8828; H01M 4/9025; H01M 2004/8684; H01M 2004/8689

(57) ABSTRACT

A solid oxide fuel cell includes a solid electrolyte layer, an anode provided on a first face of the solid electrolyte layer and including a porous body including an electron conductive ceramics and an oxide ion conductive ceramics, a first mixed layer provided on the anode and having a structure in which a metallic material and a ceramics material are mixed, a first support provided on the first mixed layer and having a main component of metal, a cathode provided on a second face of the solid electrolyte layer and including a porous body including an electron conductive ceramics and an oxide ion conductive ceramics, a second mixed layer provided on the cathode and having a structure in which a metallic material and a ceramics material are mixed, and a second support provided on the second mixed layer and having a main component of metal. One of an outer periphery of the anode, the first mixed layer and the first support and an outer periphery of the cathode, the second mixed layer and the second support is positioned inwardly with respect to other.

### TECHNICAL FIELD

The present invention relates to a solid oxide fuel cell and a manufacturing method of the solid oxide fuel cell.

### BACKGROUND ART

In order to develop a solid oxide fuel cell system that can be used in automobiles or the like, it is desirable to develop a cell that can withstand vibration and not crack even when the temperature rises rapidly. Therefore, a metal support type solid oxide fuel cell supported by a metal support has been developed (see, for example, Patent Documents 1 and 2).

### PRIOR ART DOCUMENT

### Patent Document

Patent Document 1: Japanese Patent Application Publication No. 2004-512651
Patent Document 2: Japanese Patent Application Publication No. 2020-21646

### DISCLOSURE OF THE INVENTION

### Problems to be Solved by the Invention

However, due to the structural difference between the anode and the cathode, there is a difference in thermal expansion coefficient, which may cause the solid oxide fuel cell to warp during firing. Therefore, in order to reduce the structural difference between the anode side and the cathode side, a symmetrical structure may be considered. However, there is a risk that a short circuit may occur between the metal support on the anode side and the metal support on the cathode side during firing.

The present invention has been made in view of the above problems, and an object of the present invention is to provide a solid oxide fuel cell that can suppress the occurrence of a short circuit and a method for manufacturing the same.

### Means for Solving the Problems

A solid oxide fuel cell of the present invention is characterized by including: a solid electrolyte layer including a solid oxide having oxide ion conductivity; an anode that is provided on a first face of the solid electrolyte layer, includes a porous body including an electron conductive ceramics and an oxide ion conductive ceramics, and includes an anode catalyst in the porous body; a first mixed layer that is provided on a face of the anode opposite to the solid electrolyte layer and has a structure in which a metallic material and a ceramics material are mixed; a first support that is provided on a face of the first mixed layer opposite to the solid electrolyte layer and has a main component of metal; a cathode that is provided on a second face of the solid electrolyte layer, includes a porous body including an electron conductive ceramics and an oxide ion conductive ceramics, and includes a cathode catalyst in the porous body; a second mixed layer that is provided on a face of the cathode opposite to the solid electrolyte layer and has a structure in which a metallic material and a ceramics material are mixed; a second support that is provided on a face of the second mixed layer opposite to the solid electrolyte layer and has a main component of metal, wherein one of an outer periphery of the anode, the first mixed layer and the first support and an outer periphery of the cathode, the second mixed layer and the second support is positioned inwardly with respect to other.

In the above-mentioned solid oxide fuel cell, one of the outer periphery of the anode, the first mixed layer and the first support and the outer periphery of the cathode, the second mixed layer and the second support may be positioned inwardly with respect to other by 1 mm or more.

In the above-mentioned solid oxide fuel cell, the solid oxide fuel cell may have a substantially rectangular shape in a plan view, and a/b may be 1/10 or less when a length from the outer periphery of the anode, the first mixed layer, and the first support to the outer periphery of the cathode, the second mixed layer, and the second support is “a” and a length of one side of the solid oxide fuel cell is “b”.

In the above-mentioned solid oxide fuel cell, the outer periphery of the cathode, the second mixed layer and the second support may be positioned inwardly with respect to the outer periphery of the anode, the first mixed layer and the first support.

In the above-mentioned solid oxide fuel cell, a warpage amount of the solid oxide fuel cell may be less than 4%.

In the above-mentioned solid oxide fuel cell, an average of each c/d value of voids of the cathode may be larger than an average of each c/d value of voids of the anode when a length of a void of each layer in an extension direction thereof in a cross section including a stacking direction is “c”, and a height of the void in the stacking direction is “d”, an average of each c/d value of voids of the second mixed layer may be larger than an average of each c/d value of voids of the first mixed layer, and an average of each c/d value of voids of the second support may be larger than an average of each c/d value of voids of the first support.

In the above-mentioned solid oxide fuel cell, an average of each of c/d value of the cathode, the second mixed layer and the second support may be more than 1 and less than 3.

In the above-mentioned solid oxide fuel cell, the anode catalyst may be Ni and GDC, and the cathode catalyst may include at least one of PrOₓ, LSM, LSC, and GDC.

In the above-mentioned solid oxide fuel cell, an average grain size of the anode catalyst and the cathode catalyst may be 100 nm or less.

In the above-mentioned solid oxide fuel cell, among a porosity of the first support, a porosity of the first mixed layer, and a porosity of the anode, there may be a relationship of the first support>the first mixed layer>the anode, and among a porosity of the second support, a porosity of the second mixed layer, and a porosity of the cathode, there may be a relationship of the second support>the second mixed layer>the cathode.

In the above-mentioned solid oxide fuel cell, among a thickness of the first support, a thickness of the first mixed layer, and a thickness of the anode, there may be a relationship of the first support>the first mixed layer>the anode, and among a thickness of the second support, a thickness of the second mixed layer, and a thickness of the cathode, there may be a relationship of the second support>the second mixed layer>the cathode.

A manufacturing method of a solid oxide fuel cell of the present invention is characterized by including: preparing a multilayer structure in which a support green sheet containing a metal powder, a mixed layer green sheet containing a ceramics material powder and a metallic material powder, an electrode green sheet containing an electron conductive ceramics material powder and an oxide ion conductive ceramics material powder, and an electrolyte green sheet containing a solid oxide material powder having oxide ion conductivity; and printing a slurry containing an electron conductive ceramics material powder and an oxide ion conductive ceramics material powder, a slurry containing a ceramics material powder and a metallic material powder, and a slurry containing a metal powder inwardly of the outer periphery of the electrolyte green sheet, and after that, firing the multilayer structure.

### Effects of the Invention

According to the present invention, it is possible to provide a solid oxide fuel cell that can suppress the occurrence of short circuits and a method for manufacturing the same.

### BRIEF DESCRIPTION OF THE DRAWINGS

FIG. 1A is a schematic cross-sectional view of a stacking structure of a solid oxide fuel cell;

FIG. 1B is a plan view of a fuel cell;

FIG. 2 is an enlarged cross-sectional view illustrating details of a first support, a first mixed layer, and an anode, a cathode, a second mixed layer and a second support;

FIG. 3 illustrates warpage of a fuel cell;

FIG. 4 illustrates a shape of voids;

FIG. 5A and FIG. 5B illustrate shapes of voids;

FIG. 6A and FIG. 6B illustrate a measuring method of a length “c” and a heigh “d”

FIG. 7 illustrates a flow of a manufacturing method of a fuel cell; and

FIG. 8 shows a relationship between a thermal treatment temperature at which gas leakage was detected and a c/d value.

### BEST MODES FOR CARRYING OUT THE INVENTION

Hereinafter, an embodiment will be described with reference to the accompanying drawings.

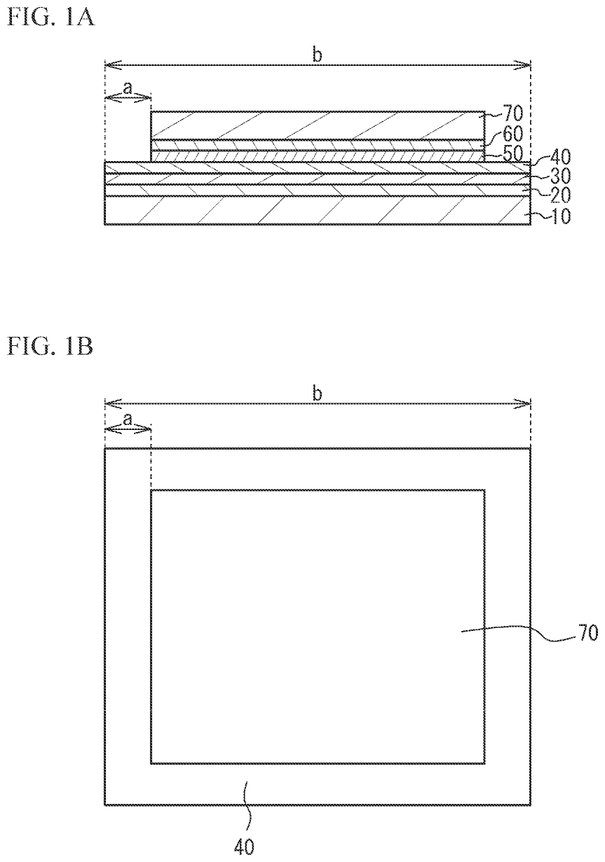

FIG. 1A is a schematic cross-sectional view illustrating a multilayer structure of a fuel cell 100 which is a solid oxide type. FIG. 1B is a plan view of the fuel cell 100. As illustrated in FIG. 1A, the fuel cell 100 has an anode 30 on a first surface of a solid electrolyte layer 40, a first mixed layer 20 on a surface of the anode 30 opposite to the solid electrolyte layer 40, a first support 10 on the first mixed layer 20 opposite to the solid electrolyte layer 40, a cathode 50 on a second surface of the solid electrolyte layer 40, a second mixed layer 60 on the cathode 50 opposite to the solid electrolyte layer 40, and a second support 70 on the second mixed layer 60 opposite to the solid electrolyte layer 40. A plurality of fuel cells 100 may be stacked to form a fuel cell stack.

As illustrated in FIG. 1A and FIG. 1B, the first support 10, the first mixed layer 20, the anode 30 and the solid electrolyte layer 40 are rectangular (for example, square) of approximately the same size. In addition, the positions of the outer peripheries (side surfaces) of the first support 10, the first mixed layer 20, the anode 30 and the solid electrolyte layer 40 are substantially aligned. Therefore, the outer peripheries of the first support 10, the first mixed layer 20, the anode 30 and the solid electrolyte layer 40 form outer peripheral surfaces. The length of one side of the rectangular shape of the first support 10, the first mixed layer 20, the anode 30 and the solid electrolyte layer 40 is referred to as length “b”.

The cathode 50, the second mixed layer 60 and the second support 70 have substantially the same rectangular shape (for example, square shape). In addition, the positions of the outer peripheries (side surfaces) of the cathode 50, the second mixed layer 60 and the second support 70 are substantially aligned. Accordingly, the outer peripheries of the cathode 50, the second mixed layer 60 and the second support 70 form outer peripheral surfaces.

The outer peripheral surfaces of the cathode 50, the second mixed layer 60 and the second support 70 are located inside the outer peripheral surfaces of the first support 10, the first mixed layer 20, the anode 30 and the solid electrolyte layer 40. The length from each of the outer peripheral surfaces of the first support 10, the first mixed layer 20, the anode 30 and the solid electrolyte layer 40 to each of the outer peripheral surfaces of the cathode 50, the second mixed layer 60 and the second support 70 is referred to as length “a”.

In FIG. 1A and FIG. 1B, the outer peripheral surfaces of the cathode 50, the second mixed layer 60 and the second support 70 are positioned inside the outer peripheral surfaces of the first support 10, the first mixed layer 20, the anode 30 and the solid electrolyte layer 40. The outer peripheral surfaces of the first support 10, the first mixed layer 20, the anode 30 and the solid electrolyte layer 40 may be inside the outer peripheral surfaces of the cathode 50, the second mixed layer 60 and the second support 70. The outer peripheral surfaces of the solid electrolyte layer 40 substantially matches the outer peripheral surfaces of the cathode 50, the second mixed layer 60 and the second support 70.

The solid electrolyte layer 40 is a dense layer that is mainly composed of solid oxide having oxygen ion conductivity and has gas impermeability. The solid electrolyte layer 40 is preferably mainly composed of scandia-yttria-stabilized zirconium oxide (ScYSZ). The oxygen ion conductivity is the highest when the concentration of Y₂O₃+Sc₂O₃ is 6 mol % to 15 mol %. Thus, use of a material having this composition is preferable. The thickness of the solid electrolyte layer 40 is preferably 20 μm or less, further preferably 10 μm or less. The thinner electrolyte layer is better. However, to prevent gas at the both sides from leaking, the thickness is preferably 1 μm or greater.

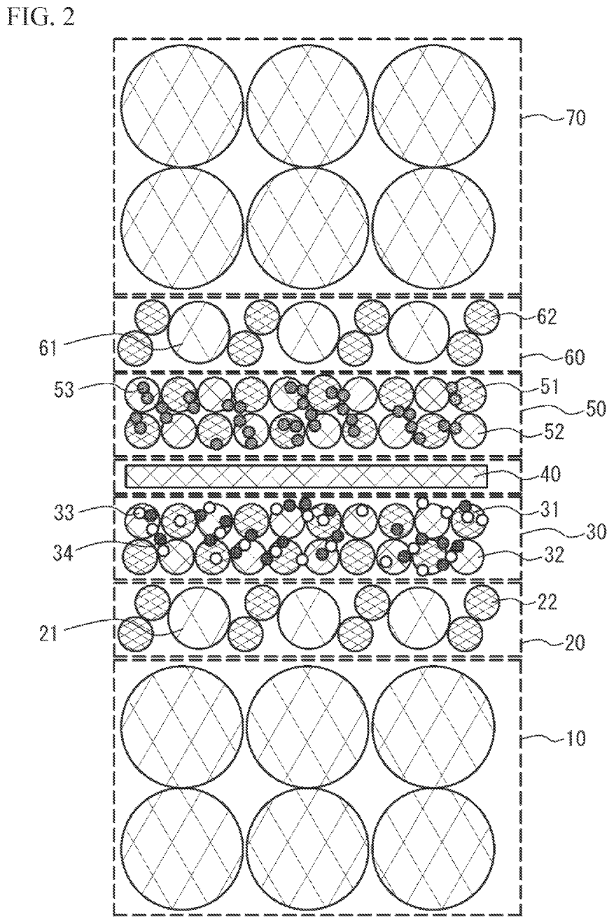

FIG. 2 is an enlarged cross-sectional view illustrating details of the first support 10, the first mixed layer 20, the anode 30, the cathode 50, the second mixed layer 60 and the second support 70.

The first support 10 is a member that has gas permeability and is able to support the first mixed layer 20, the anode 30, the solid electrolyte layer 40, the cathode 50 and the second mixed layer 60. The first support 10 is a metal porous metallic body, and is, for example, a porous material of Fe—Cr alloys.

The anode 30 is an electrode having electrode activity as an anode, and has a porous body (electrode bone structure) made of a ceramics material. The porous body contains no metallic component. In this configuration, decrease in the porosity in the anode due to coarsening of a metallic component is inhibited during firing in a high-temperature reductive atmosphere. Additionally, alloying with a metallic component of the first support 10 is inhibited, and deterioration of the catalyst function is inhibited.

The porous body of the anode 30 preferably has electron conductivity and oxygen ion conductivity. The anode 30 contains an electron conductive ceramics 31. The electron conductive ceramics 31 can be a perovskite-type oxide expressed by the composition formula of ABO₃ where the A site is at least one selected from a group consisting of Ca, Sr, Ba, and La, and the B site includes at least one selected from a group consisting of Ti and Cr. The mole fraction of the B site may be equal to or greater than the mole fraction of the A site (B≥A). More specifically, the electron conductive ceramics 31 can be a LaCrO₃-based material, SrTiO₃-based material, or the like.

The porous body of the anode 30 contains an oxide ion conductive ceramics 32. The oxide ion conductive ceramics 32 is ScYSZ or the like. For example, it is preferable to use ScYSZ having the following composition range. Scandia (Sc₂O₃) is 5 mol % to 16 mol %, and yttria (Y₂O₃) is 1 mol % to 3 mol %. It is more preferable to use ScYSZ of which the total additive amount of scandia and yttria is 6 mol % to 15 mol %. This is because the highest oxide ion conductivity is obtained in this composition range. The oxide ion conductive ceramics 32 is, for example, a material with a transference number of oxide ion of 99% or greater. GDC may be used as the oxide ion conductive ceramics 32. In the example of FIG. 2, a solid oxide identical to the solid oxide contained in the solid electrolyte layer 40 is used as the oxide ion conductive ceramics 32.

As illustrated in FIG. 2, in the anode 30, for example, the electron conductive ceramics 31 and the oxide ion conductive ceramics 32 form the porous body. This porous body forms a plurality of voids. The porosity of the porous body is preferably 20% or more in an area ratio in a cross section thereof. An anode catalyst is carried on the surface exposed to the void of the porous body. Thus, in the spatially continuously formed porous body, a plurality of anode catalysts are spatially dispersed. A composite catalyst is preferably used as the anode catalyst. For example, an oxide ion conductive ceramics 33 and a catalyst metal 34 are preferably carried, as a composite catalyst, on the surface of the porous body. The oxide ion conductive ceramics 33 may be, for example, BaCe₁₋ₓZrxO₃ doped with Y (BCZY, x=0 to 1), SrCe₁₋ₓZrxO₃ doped with Y (SCZY, x=0 to 1), LaScO₃ doped with Sr (LSS), or GDC. Ni or the like may be used as the catalyst metal 34. The oxide ion conductive ceramics 33 may have a composition identical to that of the oxide ion conductive ceramics 32, or may have a composition different from that of the oxide ion conductive ceramics 32. A metal acting as the catalyst metal 34 may be in a form of compound when electric power is not generated. For example, Ni may be in a form of a nickel oxide (NiO). These compounds are reduced with a reductive fuel gas supplied to the anode 30, and becomes in a form of metal acting as an anode catalyst.

The first mixed layer 20 contains a metallic material 21 and a ceramics material 22. In the first mixed layer 20, the metallic material 21 and the ceramics material 22 are randomly mixed. Thus, a structure in which a layer of the metallic material 21 and a layer of the ceramics material 22 are stacked is not formed. The first mixed layer 20 has a plurality of voids. The metallic material 21 is not particularly limited as long as the metallic material 21 is a metal. In the example of FIG. 2, a metallic material identical to the metallic material of the first support 10 is used as the metallic material 21. As the ceramics material 22, the electronic conductive ceramics 31, the oxide ion conductive ceramics 32, or the like can be used. For example, ScYSZ, GDC, a SrTiO₃-based material, or a LaCrO₃-based material can be used as the ceramics material 22. Since the SrTiO₃-based material and the LaCrO₃-based material have high electron conductivity, the ohmic resistance in the first mixed layer 20 can be reduced.

The cathode 50 is an electrode having electrode activity as a cathode, and has a porous body (electrode bone structure) made of a ceramics material. The porous body contains no metallic component. The porous body of the cathode 50 has electron conductivity and oxygen ion conductivity. The cathode 50 contains an electron conductive ceramics 51. The electron conductive ceramics 51 can be a perovskite-type oxide expressed by the composition formula of ABO₃ where the A site is at least one selected from a group consisting of Ca, Sr, Ba, and La, and the B site includes at least one selected from a group consisting of Ti and Cr. The mole fraction of the B site may be equal to or greater than the mole fraction of the A site (B≥A). More specifically, the electron conductive ceramics 51 can be a LaCrO₃-based material, SrTiO₃-based material, or the like. The electron conductive ceramics 51 preferably contains the same components as the electron conductive ceramics 31, and preferably has the same composition ratio.

The porous body of the cathode 50 contains an oxide ion conductive ceramics 52. The oxide ion conductive ceramics 52 is ScYSZ or the like. For example, it is preferable to use ScYSZ having the following composition range. Scandia (Sc₂O₃) is 5 mol % to 16 mol %, and yttria (Y₂O₃) is 1 mol % to 3 mol %. It is more preferable to use ScYSZ of which the total additive amount of scandia and yttria is 6 mol % to 15 mol %. This is because the highest oxide ion conductivity is obtained in this composition range. The oxide ion conductive ceramics 52 is, for example, a material with a transference number of oxide ion of 99% or greater. GDC may be used as the oxide ion conductive ceramics 52. It is preferable that the oxide ion conductive ceramics 52 contains the same components as the oxide ion conductive ceramics 32, and has the same composition ratio. In the example of FIG. 2, a solid oxide identical to the solid oxide contained in the solid electrolyte layer 40 is used as the oxide ion conductive ceramics 32.

As illustrated in FIG. 2, in the cathode 50, for example, the electron conductive ceramics 51 and the oxide ion conductive ceramics 52 form the porous body. This porous body forms a plurality of voids. The porosity of the porous body is preferably 20% or more in an area ratio in a cross section thereof. A cathode catalyst 53 is carried on the surface exposed to the void of the porous body. Thus, in the spatially continuously formed porous body, a plurality of the cathode catalysts 53 are spatially dispersed. Praseodymium oxide (PrOₓ), LSM (lanthanum strontium manganite), LSC (lanthanum strontium cobaltite), or the like can be used as the cathode catalyst 53. LSM is a Sr-doped LaMnO₃-based material. LSM is a Sr-doped LaCoO₃-based material.

The second mixed layer 60 contains a metallic material 61 and a ceramics material 62. In the second mixed layer 60, the metallic material 61 and the ceramics material 62 are randomly mixed. Thus, a structure in which a layer of the metallic material 61 and a layer of the ceramics material 62 are stacked is not formed. The second mixed layer 60 has a plurality of voids. The metallic material 61 is not particularly limited as long as the metallic material 61 is a metal. In the example of FIG. 2, a metallic material identical to the metallic material of the second support 70 is used as the metallic material 61. As the ceramics material 62, the electronic conductive ceramics 51, the oxide ion conductive ceramics 52, or the like can be used. For example, ScYSZ, GDC, a SrTiO₃-based material, or a LaCrO₃-based material can be used as the ceramics material 62. Since the SrTiOs-based material and the LaCrO₃-based material have high electron conductivity, the ohmic resistance in the second mixed layer 60 can be reduced.

The second support 70 is a member that has gas permeability and is able to support the second mixed layer 60, the cathode 50, the solid electrolyte layer 40, the anode 30 and the first mixed layer 20. The second support 70 is a metal porous body, and is, for example, a porous material of Fe—Cr alloys.

The fuel cell 100 generates electrical power by the following actions. An oxidant gas containing oxygen, such as air, is supplied to the cathode 50. The second support 70 is supplied with an oxidant gas containing oxygen, such as air. The oxidant gas reaches the cathode 50 via the second support 70 and the second mixed layer 60. At the cathode 50, oxygen reaching the cathode 50 reacts with electrons supplied from an external electric circuit to become oxide ions. The oxide ions conduct through the solid electrolyte layer 40 to move to the anode 30 side. On the other hand, a fuel gas containing hydrogen, such as a hydrogen gas or a reformed gas, is supplied to the first support 10. The fuel gas reaches the anode 30 through the first support 10 and the first mixed layer 20. Hydrogen reaching the anode 30 release electrons at the anode 30 and reacts with oxide ions conducting through the solid electrolyte layer 40 from the cathode 50 side to become water (H₂O). The released electrons are drawn out to the outside by the external electric circuit. The electrons drawn out to the outside are supplied to the cathode 50 after doing electric work. Through the above-described actions, electric power is generated.

In the above power generation reaction, the catalyst metal 34 functions as a catalyst in the reaction between hydrogen and oxide ions. The electron conductive ceramics 31 conducts electrons obtained by the reaction between hydrogen and oxide ions. The oxide ion conductive ceramics 32 conducts oxide ions that reach the anode 30 from the solid electrolyte layer 40. The cathode catalyst 53 functions as a catalyst in a reaction in which oxide ions are generated from oxygen gas and electrons. The electron conductive ceramics 51 conducts electrons from the external electrical circuit. The oxide ion conductive ceramics 52 conducts oxide ions to the solid electrolyte layer 40.

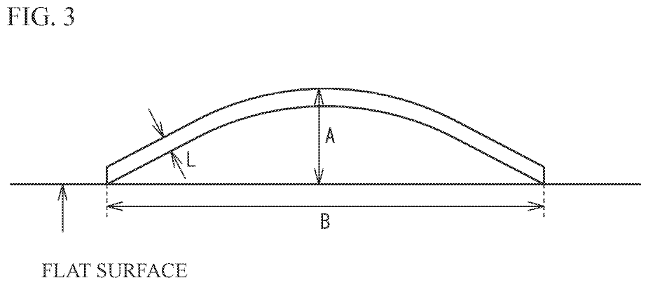

A fuel cell can be produced by stacking each layer using a powder material and firing them simultaneously. However, if there is a large difference in shrinkage behavior between the layers during the firing process, warping as illustrated in FIG. 3 occurs. If the fuel cells are warped, stress is generated in each fuel cell when stacking a plurality of fuel cells to form a stack, and the fuel cells are likely to crack.

It should be noted that, as illustrated in FIG. 3, when the cell is placed on a flat surface, the distance between both sides that come into contact with the surface is defined as a distance “B”. A vertical distance from the vertex of the warp to the flat surface is defined as a distance “A”. A thickness of the cell is defined as a thickness “L”. In this case, the amount of warp T (%) is defined as (A−L)/B×100 (%).

However, in the fuel cell 100 according to the present embodiment, both the anode 30 and the cathode 50 are porous bodies made of electron conductive ceramics and oxygen ion conductive ceramics. In this configuration, the structural difference between the anode 30 and the cathode 50 is reduced. The first mixed layer 20 is provided on the anode side, and the second mixed layer 60 is provided on the cathode side. Furthermore, the first support 10 is provided on the anode side, and the second support 70 is provided on the cathode side. Thus, the fuel cell 100 has a symmetrical structure with the solid electrolyte layer 40 as the center. As a result, the difference in shrinkage behavior of each layer during the firing process is reduced, and warping is suppressed. For example, the warp amount T (%) is less than 4%.

In addition, if the electronically conductive portion on the anode side and the electronically conductive portion on the cathode side are connected during the firing process, there is a risk of short-circuiting between the electrodes. However, since the fuel cell 100 according to the present embodiment is provided with the length “a” described in FIG. 1A. Therefore, the electronically conductive portion on the anode side and the electronically conductive portion on the cathode side are separated. Thereby, the short circuit between electrodes can be suppressed.

It should be noted that the smaller a/b is, the larger the effective power generation area is. Therefore, it is preferable to set an upper limit for a/b. For example, a/b< 1/10 is preferred, a/b< 1/20 is more preferred, and a/b< 1/50 is even more preferred. For example, in a square cell of 100 mm×100 mm, if the interval “a” is 1 mm, the area of the cathode 50 is 98 mm×98 mm.

From the viewpoint of suppressing short circuits between electrodes, the length “a” is preferably 1 mm or more, and more preferably 2 mm or more.

As described above, when the fuel cell 100 generates electrical power, the oxidant gas flows to the cathode side. Therefore, during power generation, the metal component on the cathode side may oxidize and expand, resulting in cracking.

Therefore, the fuel cell 100 preferably has a structure capable of absorbing the stress caused by oxidation expansion. For example, it is preferable that the stress can be absorbed by the shape of the voids formed in each layer. Details will be described below.

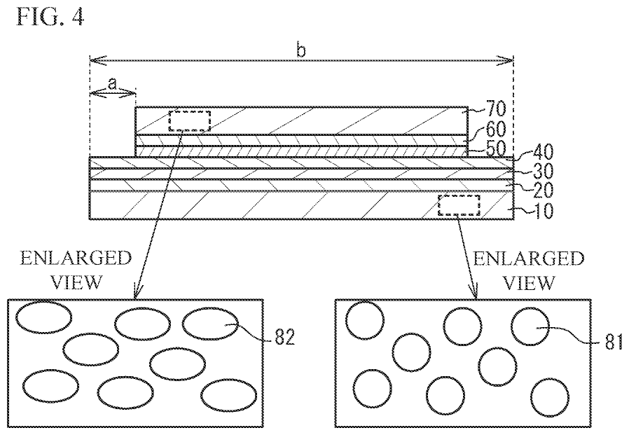

FIG. 4 illustrates the shape of voids 81 formed in the cross section of the first support 10, the first mixed layer 20, and the anode 30 and illustrates the shape of voids 82 in the cross sections of the second support 70, the second mixed layer 60 and the cathode 50. As illustrated in FIG. 4, the voids 81 formed in the first support 10, the first mixed layer 20, and the anode 30 preferably have a substantially circular shape. On the other hand, the voids 82 formed in the second support 70, the second mixed layer 60, and the cathode 50 preferably have a substantially elliptical shape.

Here, in the cross section cut in the stacking direction, the length of the closed void in the direction in which each layer extends (hereinafter also referred to as the lateral direction) is defined as length “c”, and the height of the void in the stacking direction is defined as height “d”. The length “c” is the maximum lateral length within one void in the lateral direction. The height “d” is the maximum height within one void in the stacking direction.

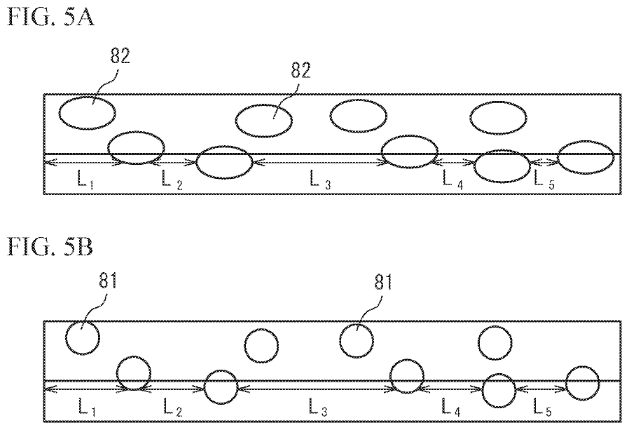

The larger the c/d is, the shorter the length of the material that fills the space between the voids in each layer is. Therefore, expansion in the lateral direction is moderated, and the solid electrolyte layer 40 is less likely to crack. As illustrated in FIG. 5A and FIG. 5B, in the lateral direction, the length L of the material between the voids is L1+L2+L3+L4+L5. An increase in length due to thermal expansion is calculated by ΔL=L×linear expansion coefficient. The increase in length due to oxidation is calculated as ΔL=L×oxidation expansion coefficient. In any case, the coefficient of linear expansion and the coefficient of oxidative expansion are physical property values, and are constants once the material is determined. Therefore, it can be seen that the length increase ΔL is proportional to L. When the elliptical void 82 in FIG. 5A and the perfect circular void 81 in FIG. 5B are compared, the total material length L per unit length of FIG. 5A is smaller than that of FIG. 5B. Therefore, it can be seen that the length increase ΔL is also smaller for the elliptical void 82. The smaller ΔL is, the more the mismatch with the solid electrolyte layer 40 is relaxed, so the solid electrolyte layer 40 becomes more difficult to crack.

Since oxidation expansion occurs on the cathode side and oxidation expansion does not occur on the anode side, it is preferable that the c/d on the cathode side is larger than the c/d on the anode side. Therefore, it is preferable that the average value of the c/d for the multiple voids formed in the cathode 50 is larger than the average value of each c/d for the multiple voids formed in the anode 30. It is preferable that the average value of the c/d for the plurality of voids formed in the second mixed layer 60 is larger than the average value of each c/d for the plurality of voids formed in the first mixed layer 20. It is preferable that the average value of the c/d for the plurality of voids formed in the second support 70 is larger than the average value of each c/d for the plurality of voids formed in the first support 10.

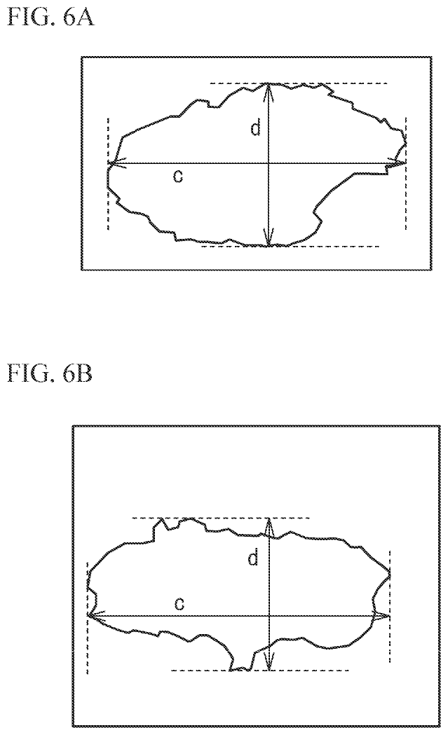

Here, the method of measuring the length “c” and the height “d” will be explained. Real air gaps have irregular perimeter shapes rather than ideal ellipses. A cross section of the cell is observed with an SEM, and the length “c” and the height “d” are measured from the SEM photograph. As illustrated in FIG. 6A and FIG. 6B, the longest distance in the lateral direction of the gap is defined as “c”, and the longest distance in the vertical direction is defined as “d”. The cathode 50, the second mixed layer 60, and the second support 70 are all measured in the same way. 20 or more of the length “c” and 20 or more of the height “d” are measured with respect to each layer, and an average value of the 20 or more of the length “c” us considered as the length “c” and an average value of the 20 or more of the height “d” is considered as the height “d”. Using these average length “c” and the average height “d”, the value of c/d at each layer can be calculated. The length “c” and the height “d” of the voids of the first support 10, the first mixed layer 20, and the anode 30 can also be measured in the same manner.

From the viewpoint of increasing the c/d on the cathode side, the average value of c/d for each of the cathode 50, the second mixed layer 60, and the second support 70 is preferably more than 1. The average valu2 of c/d is more preferably greater than 1.5, and even more preferably greater than 1.5.

On the other hand, if c/d is too large, cracks may occur on the surface of the fired porous layer (the cathode 50, the second mixed layer 60 and the second support 70). Therefore, it is preferable to provide an upper limit to c/d. For example, the average value of c/d for each of the cathode 50, the second mixed layer 60, and the second support 70 is preferably less than 3, more preferably less than 2.5, and even more preferably less than 2.

Note that if both the anode 30 and the cathode 50 are porous bodies made of electron-conducting ceramics and oxygen-ion-conducting ceramics, the structural difference between the anode 30 and the cathode 50 is reduced. Therefore, the anode 30 and the cathode 50 can be fired simultaneously. As a result, the adhesion of the anode 30 and the cathode 50 to the solid electrolyte layer 40 is improved, film peeling is suppressed, and the ohmic resistance of the fuel cell 100 as a whole is reduced.

In addition, since the fuel cell 100 includes the first support 10 and the second support 70 mainly composed of metal, the fuel cell 100 has a structure that is resistant to thermal shock, mechanical shock, and the like. Moreover, since the first mixed layer 20 contains the metallic material 21 and the ceramics material 22, the first mixed layer 20 has both the material properties of metal and the material properties of ceramics. Therefore, the first mixed layer 20 has high adhesion with the first support 10 and has high adhesion with the anode 30. As described above, delamination between the first support 10 and the anode 30 can be suppressed. Since the second mixed layer 60 contains the metallic material 61 and the ceramics material 62, the second mixed layer 60 has both the material properties of metal and the material properties of ceramics. Therefore, the second mixed layer 60 has high adhesion with the second support 70 and has high adhesion with the cathode 50. As described above, delamination between the second support 70 and the cathode 50 can be suppressed.

In addition, in the fuel cell 100, the oxide ion conductive ceramics 33 is supported on the porous body of the anode 30. In this structure, it is possible to first form the porous body by firing, and then impregnate the porous body with the oxide ion conductive ceramics 33 and fire the oxide ion conductive ceramics 33 at a low temperature. Therefore, even if the oxide ion conductive ceramics 32 and the oxide ion conductive ceramics 33 do not have the same composition, the reaction between the oxides is suppressed. Therefore, the degree of freedom in selecting an oxide suitable for the composite catalyst as the oxide ion conductive ceramics 33 is increased.

Similarly, in the fuel cell 100, the cathode catalyst 53 is supported on the porous body of the cathode 50. In this structure, it is possible to first form the porous body by firing, and then impregnate the cathode catalyst 53 and fire the cathode catalyst at a low temperature. Therefore, even if the oxide ion conductive ceramics 52 and the cathode catalyst 53 do not have the same composition, the reaction between the oxides is suppressed. Therefore, the degree of freedom in selecting a preferable oxide for the cathode catalyst 53 is increased.

In addition, among the porosity of the first support 10, the porosity of the first mixed layer 20, and the porosity of the anode 30, there is a relationship of (the first support 10>the first mixed layer 20>the anode 30). It is preferable that a relationship of (the second support 70>the second mixed layer 60>the cathode 50) is established among the porosity of the second support 70, the porosity of the second mixed layer 60, and the porosity of the cathode 50. By establishing these relationships, the support can have sufficient gas permeability. In the electrode, having a relatively low porosity provides high electronic conductivity and high oxide ion conductivity while maintaining gas permeability. In the mixed layer, gas permeability is obtained, and a contact area with the support is obtained, so that adhesion with the support is obtained.

Further, it is preferable that the thickness of the first support 10, the thickness of the first mixed layer 20, and the thickness of the anode 30 satisfy the relationship of the first support 10>the first mixed layer 20>the anode 30. It is preferable that the thickness of the second support 70, the thickness of the second mixed layer 60, and the thickness of the cathode 50, the relationship of the second support 70>the second mixed layer 60>the cathode 50 is established. When these relationships are established, most of the volume (for example, 80% or more) of the entire fuel cell 100 is made of a metal material, so that effects of improvement of the mechanical strength with respect to such as rapid heating and cooling, or flexibility can be obtained.

Since the anode reaction and the cathode reaction are chemical reactions that occur on the surface of the catalyst, it is preferable that the surface area per unit volume of the catalyst is large from the viewpoint of promoting the chemical reaction. For example, the average crystal grain size of the anode catalyst (the oxide ion conductive ceramics 33 and the catalyst metal 34) and the cathode catalyst 53 is preferably 100 nm or less, more preferably 80 nm or less, and even more preferably 50 nm or less.

If the thicknesses of the anode 30 and the cathode 50, the thicknesses of the first mixed layer 20 and the second mixed layer 60, and the thicknesses of the first support 10 and the second support 70 increase in variation, the structure of the fuel cell 100 approaches an asymmetrical structure. In this case, the thermal stress between the upper and lower materials is not canceled, and the fuel cell 100 may warp. Therefore, for example, it is preferable that the thickness of the anode 30 is within ±50% of the thickness of the cathode 50, the thickness of the first mixed layer 20 is within ±50% of the thickness of the second mixed layer 60, and the thickness of the first support 10 is within ±50% of the thickness of the support 70.

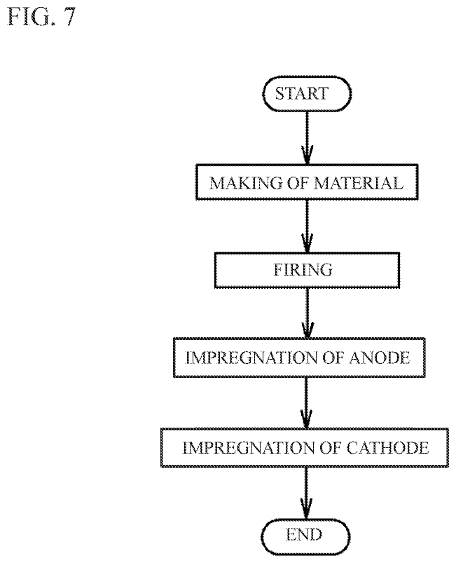

In the following, a description will be given of a manufacturing method of the fuel cell 100. FIG. 7 illustrates a flow of the manufacturing method of the fuel cell 100.

(Making Process of Material for First Support and Second Support) Metallic powder (for example, a particle size of 10 μm to 100 μm,) a plasticizer (The amount of the plasticizer is adjusted to, for example, 1 wt % to 6 wt % to adjust the adhesiveness of the sheet.), a solvent (toluene, 2-propanol (IPA), 1-butanol, terpineol, butyl acetate, ethanol, or the like. The amount of the solvent is 20 wt % to 30 wt % depending on the viscosity or the like.), a vanishing material (an organic substance), and a binder (PVB, acrylic resin, ethyl cellulose, or the like) are mixed to make slurry as a material for support. The material for support is used as a material for forming the support. The ratio of the volume of the organic components (the vanishing material, the solid component of the binder, and the plasticizer) to the volume of the metallic powder is within a range of, for example, 1:1 to 20:1. The amount of the organic components is adjusted depending on the porosity. In the material for the first support, circular resin particles are used as the vanishing material. In the material for the second support, elliptical resin particles are used as the vanishing material.

(Making Process of Material for First Mixed Layer and Second Mixed Layer) As a material for mixed layer, ceramic material powder (for example, a particle size of 100 nm to 10 μm) that is a raw material for the ceramics materials 22 and 62, small-particle-size metal material powder that is a raw material for the metallic materials 21 and 61 (for example, a particle size of 1 μm to 10 μm), a solvent (toluene, 2-propanol (IPA), 1-butanol, terpineol, butyl acetate, ethanol or the like, 20 wt % to 30 wt % depending on viscosity), a plasticizer (The amount of the plasticizer is adjusted to, for example, 1 wt % to 6 wt % to adjust the adhesiveness of the sheet.), a vanishing material (organic matter), and a binder (PVB, acrylic resin, ethyl cellulose, etc.) are mixed to form a slurry. The ratio of the volume of the organic components (the vanishing material, the solid component of the binder, and the plasticizer) to the volume of the ceramic material powder and the metallic material powder is within a range of, for example, 1:1 to 5:1. The amount of the organic components is adjusted depending on the porosity. The diameter of the void is controlled by adjusting the particle size of the vanishing material. The ceramic material powder may contain powder of an electron conductive material and powder of an oxide-ion conductive material. In this case, the ratio of the volume of the powder of the electron conductive material to the volume of the powder of the oxide-ion conductive material is preferably within a range of, for example, 1:9 to 9:1. Use of an electrolyte material such as ScYSZ, GDC, or the like instead of the electron conductive material also prevents the peeling of the boundary face and enables the manufacture of the cell. However, to reduce the ohmic resistance, it is preferable to mix an electron conductive material and metallic powder. In the material for the first mixed layer, circular resin particles are used as the vanishing material. In the material for the second mixed layer, elliptical resin particles are used as the vanishing material.

(Making Process of Material for Anode) As a material for the anode, a ceramic material powder constituting the porous body, solvent (toluene, 2-propanol (IPA), 1-butanol, terpineol, butyl acetate, ethanol, etc., 20 wt % to 30 wt % depending on viscosity), plasticizer (The amount of the plasticizer is adjusted to, for example, 1 wt % to 6 wt % to adjust the adhesiveness of the sheet.), a vanishing material (organic matter), and a binder (PVB, acrylic resin, ethyl cellulose, etc.) are mixed to form a slurry. Powder of the electron conductive material that is the raw material of the electron conductive ceramics 31 and has a particle size of, for example, 100 nm to 10 μm and powder of the oxide ion conductive material that is the raw material of the oxide ion conductive ceramics 32 and has a particle size of, for example, 100 nm to 10 μm may be used as the ceramic material powder structuring the porous body. The ratio of the volume of the organic components (the vanishing material, the solid component of the binder, and the plasticizer) to the volume of the powder of the electron conductive material is within a range of, for example, 1:1 to 5:1, and the amount of the organic components is adjusted depending on the porosity. Additionally, the diameter of the void is controlled by adjusting the particle size of the vanishing material. The ratio of the volume of the powder of the electron conductive material to the volume of the powder of the oxygen ion conductive material is within a range of, for example, 1:9 to 9:1. In the material of the anode, circular resin particles are used as the vanishing material.

(Making Process of Material for Cathode) As a material for the cathode, a ceramic material powder constituting the porous body, a solvent (toluene, 2-propanol (IPA), 1-butanol, terpineol, butyl acetate, ethanol, etc., 20 wt % to 30 wt % depending on viscosity), plasticizer (The amount of the plasticizer is adjusted to, for example, 1 wt % to 6 wt % to adjust the adhesiveness of the sheet.), a vanishing material (organic matter), and a binder (PVB, acrylic resin, ethyl cellulose, etc.) are mixed to form a slurry. Powder of the electron conductive material that is the raw material of the electron conductive ceramics 51 and has a particle size of, for example, 100 nm to 10 μm and powder of the oxide ion conductive material that is the raw material of the oxide ion conductive ceramics 52 and has a particle size of, for example, 100 nm to 10 μm may be used as the ceramic material powder structuring the porous body. The ratio of the volume of the organic components (the vanishing material, the solid component of the binder, and the plasticizer) to the volume of the powder of the electron conductive material is within a range of, for example, 1:1 to 5:1, and the amount of the organic components is adjusted depending on the porosity. Additionally, the diameter of the void is controlled by adjusting the particle size of the vanishing material. The ratio of the volume of the powder of the electron conductive material to the volume of the powder of the oxygen ion conductive material is within a range of, for example, 1:9 to 9:1. In addition, when the material for the anode and the material for the cathode are common, the material for the anode material may be used as the material for the cathode. In the material for the cathode, elliptical resin particles are used as the vanishing material.

(Making Process of Material for Electrolyte Layer) As a material for the electrolyte layer, oxide ion conductive material powder (for example, ScYSZ, YSZ, GDC or the like with a particle size of 10 nm to 1000 nm), a solvent (toluene, 2-propanol (IPA), 1-butanol, terpineol, butyl acetate, ethanol or the like, 20 wt % to 30 wt % depending on the viscosity), a plasticizer (The amount of the plasticizer is adjusted to, for example, 1 wt % to 6 wt % to adjust the adhesiveness of the sheet.), and a binder (PVB, acrylic resin, ethyl cellulose, etc.) to form a slurry. The ratio of the volume of the organic components (the solid component of the binder and the plasticizer) to the volume of the powder of the oxygen ion conductive material is within a range of, for example, 6:4 to 3:4.

(Firing Process) A first support green sheet is made by applying the material for the first support on a polyethylene terephthalate (PET) film. A first mixed layer green sheet is made by applying the material for the first mixed layer on another PET film. An anode green sheet is made by applying the material for the anode on yet another PET film. An electrolyte layer green sheet is made by applying the material for the electrolyte layer on yet another PET film. For example, several first support green sheets, one first mixed layer green sheet, one anode green sheet, and one electrolyte layer green sheet are stacked in this order. The outer peripheries of the first support green sheet, the first mixed layer green sheet, the anode green sheet, and the electrolyte layer green sheet are matched. Each periphery may be matched by cutting the multilayer structure into a predetermined size. After that, a slurry of the material for the cathode is printed on the electrolyte green sheet. After drying, a slurry of the material for the second mixed layer is printed on the material for the cathode. After drying, the material for the second support is thickly coated on the material for the second mixed layer by repeating printing and drying the slurry of the material for the second support several times. When printing the slurry of the material for the cathode, the slurry of the material for the second mixed layer, and the slurry of the material for the second support, in order to orient the ellipsoidal resin particles in the longitudinal direction parallel to the printing direction, the slurry is subjected to appropriate centrifugation conditions prior to printing. Further, the slurry of the material for the cathode, the slurry of the material for the second mixed layer, and the slurry of the material for the second support are printed inside the outer periphery of the electrolyte green sheet. After that, the multilayer structure is fired at a temperature range of about 1100° C. to 1300° C. in a reducing atmosphere with an oxygen partial pressure of 10⁻¹⁶ atm or less. Thereby, a cell comprising the first support 10, the first mixed layer 20, the porous body of the anode 30, the solid electrolyte layer 40, the porous body of the cathode 50, the second mixed layer 60, and the second support 70 can be obtained. The reducing gas flowing into the furnace may be a gas obtained by diluting H₂ (hydrogen) with a nonflammable gas (Ar (argon), He (helium), N₂ (nitrogen), etc.) or a gas containing 100% H₂. In consideration of safety, it is preferable to set an upper limit up to the explosion limit. For example, in the case of a mixed gas of H₂ and Ar, the concentration of H₂ is preferably 4% by volume or less.

(Anode Impregnating Process) Next, the porous body of the anode 30 is impregnated with the raw materials of the oxide ion conductive ceramics 33 and the catalyst metal 34. For example, the following process is repeated as many times as needed such that Gd-doped ceria or Sc, Y-doped zirconia and Ni are generated when the cell is fired in a reductive atmosphere at a predetermined temperature. Nitrate or chloride of Zr, Y, Sc, Ce, Gd, or Ni is dissolved in water or alcohol (ethanol, 2-propanol, methanol or the like). The porous body of the anode 30 is impregnated with the resulting solution, and dried. The resulting porous body is subjected to heat treatment.

(Cathode Impregnating Process) Next, the porous body of the cathode 50 is impregnated with the cathode catalyst 53 such as PrOₓ. When PrOₓ is used as the cathode catalyst 53, for example, nitrate or chloride of Pr is dissolved in water or alcohols (ethanol, 2-propanol, methanol or the like), impregnated into the porous body of the cathode 50, dried, and heat-treated a required number of times. When LSM is used as the cathode catalyst 53, for example, nitrate or chloride of Sr, nitrate or chloride of La, nitrate or chloride of Mn are dissolved in water or alcohols (ethanol, 2-propanol, methanol or the like), the half-cell is impregnated, dried, and the heat treatment is repeated a required number of times. When LSC is used as the cathode catalyst 53, for example, nitrate or chloride of Sr, nitrate or chloride of La, nitrate or chloride of Co are dissolved in water or alcohols (ethanol, 2-propanol, methanol or the like), the half-cell is impregnated, dried, and the heat treatment is repeated a required number of times.

According to the manufacturing method according to the present embodiment, when firing the anode 30 and the cathode 50, both the anode 30 and the cathode 50 include the electron conductive material and the oxide ion conductive material. Therefore, the structural difference between the porous body of the anode 30 and the porous body of the cathode 50 is reduced. Also, the first mixed layer 20 is fired on the anode side, and the second mixed layer 60 is fired on the cathode side. Furthermore, the first support 10 is fired on the anode side, and the second support 70 is fired on the cathode side. Thus, the fuel cell 100 has a symmetrical structure with the solid electrolyte layer 40 as the center. As a result, the difference in shrinkage behavior of each layer during the firing process is reduced, and warping is suppressed. For example, the warp amount T (%) is less than 4%.

Further, the slurry of the material for the cathode electrode, the slurry of the material for the second mixed layer, and the slurry of the material for the second support are printed inward from the outer periphery of the electrolyte green sheet. As a result, the electron-conductive portion on the anode side and the electron-conductive portion on the cathode are separated from each other, and short circuits between the electrodes can be suppressed.

Also, by making the shape of the vanishing material on the anode side and the shape of the vanishing material on the cathode side different, the c/d on the cathode side can be made larger than the c/d on the anode side. For example, the average value of each c/d for the plurality of voids formed in the cathode 50 can be greater than the average value of each c/d for the plurality of voids formed in the anode 30. The average value of each c/d for the plurality of voids formed in the second mixed layer 60 can be made larger than the average value of each c/d for the plurality of voids formed in the first mixed layer 20. The average value of each c/d for the plurality of voids formed in the second support 70 can be made larger than the average value of each c/d for the plurality of voids formed in the first support 10.

In addition, since the structural difference between the porous body of the anode 30 and the porous body of the cathode 50 is reduced, the anode 30 and the cathode 50 can be fired simultaneously. As a result, the adhesion of the anode 30 and the cathode 50 to the solid electrolyte layer 40 is improved, film peeling is suppressed, and the ohmic resistance of the fuel cell 100 as a whole is reduced.

Also, since the material for the first mixed layer contains the metallic material and the ceramics material, the first mixed layer 20 after firing contains the metallic material 21 and the ceramics material 22. Thereby, the first mixed layer 20 has both the material properties of metal and the material properties of ceramics. Therefore, delamination between the first support 10 and the anode 30 can be suppressed during the firing process. Since the material for the second mixed layer contains the metal material and the ceramics material, the second mixed layer 60 after firing contains the metallic material 61 and the ceramics material 62. Thereby, the second mixed layer 60 has both the material properties of metal and the material properties of ceramics. Therefore, delamination between the second support 70 and the cathode 50 can be suppressed during the firing process.

It is preferable to adjust the amount of the vanishing material in the material for the support material, the vanishing material in the material for the mixed layer material, the vanishing material in the material for the anode material, and the vanishing material in the material for the cathode, so that a relationship of (the first support 10>the first mixed layer 20>the anode 30) is established among the porosity of the first support 10, the porosity of the first mixed layer 20, and the porosity of the anode 30 and a relationship (the second support 70>the second mixed layer 60>the cathode 50) is established among the porosity of the second support 70, the porosity of the second mixed layer 60, and the porosity of the cathode 50. By establishing these relationships, the support can have sufficient gas permeability. Electrodes are dense and have high oxide ion conductivity. In the mixed layer, gas permeability is obtained, and a contact area with the support is obtained, so that adhesion with the support is obtained.

In addition, in the manufacturing method according to the present embodiment, it is possible to first form the porous body by sintering, and then impregnate the porous body with the composite catalyst and sinter the composite catalyst at a low temperature (for example, 850° C. or lower). Therefore, the reaction between the porous body of the anode 30 and the anode catalyst is suppressed. Moreover, the reaction between the porous body of the cathode 50 and the cathode catalyst is suppressed. Therefore, the degree of freedom in selecting the anode catalyst and the cathode catalyst is increased.

### Examples

The fuels cell 100 were manufactured according to the manufacturing method according to the above embodiment.

(Example 1) SUS (stainless steel) powder was used as the material for the support. ScYSZ was used as the electrolyte layer. A LaCrO₃-based material was used for the electron conductive ceramics of the anode, and ScYSZ was used for the oxide ion conductive ceramics of the anode. A LaCrO₃-based material was used for the electron conductive ceramics of the cathode, and ScYSZ was used for the oxide ion conductive ceramics of the cathode. A LaCrO₃-based material was used as the ceramic material for the mixed layer. SUS was used as the metal material of the mixed layer.

A support green sheet, a mixed layer green sheet, an anode green sheet, and an electrolyte green sheet were stacked in this order, and a material for a cathode was printed thereon and dried. A material for mixed layer was printed thereon and dried. A material for support was printed thereon and dried. After that, a sintering process was performed to produce a single cell having a symmetrical structure. In order to adjust the c/d, the size in the length direction of the ellipsoidal vanishing material in the cathode material, the cathode side mixed layer material, and the cathode side support material was R, and the size in the short direction was r. The resin of R/r=1.5/1 was used. The cell size was 100 mm×100 mm, with a 1 mm gap from the periphery when printing on the cathode side. That is, the opposite side was printed with an area of 98 mm×98 mm. A plurality of cells were produced, and cross-sectional SEM observation was performed on one of them. Each average c/d of the cathode, the second mixed layer, and the second support measured from the SEM image was 1.5. It is considered that R/r=c/d=1.5 because the voids generated by the vanishing material shrunk anisotropically as sintering progressed. On the other hand, a spherical vanishing material was used on the anode side, and as sintering progressed, the vanishing material shrunk anisotropically, and R/r=c/d=1. The anode side was impregnated with Ni and GDC for an area of 98 mm×98 mm, and the cathode side was impregnated with LSM for an area of 98 mm×98 mm.

When the warp was evaluated, the warp was less than 1%. It is considered that this was because of the symmetrical structure. Also, no short circuit between electrodes occurred. It is considered that this was because a space was taken from the outer periphery when printing on the cathode side. When performing power generation evaluation, evaluation was performed in a state in which one cell was sandwiched between upper and lower interconnectors. Moreover, there was no current collector between the cell and the interconnectors, and they were connected by laser welding.

As a result of power generation evaluation, each resistance value was separated by impedance measurement, and the ohmic resistance of this cell was 0.3 Ω·cm² and the reaction resistance was 0.7 Ω·cm². The effective power generation area utilization rate of the cell was (98×98)/(100×100)=96%. The larger the effective area is, the higher the current that can be extracted from the cell was. Therefore, the current that flowed when the terminal voltage was 0.9V was 19.1 A.

(Example 2) In Example 2, when printing the material for cathode, the material for mixed layer and the material for support, a space of 2 mm was taken from the outer periphery. That is, printing was performed with an area of 96 mm×96 mm. Other conditions were the same as in Example 1. A plurality of cells were produced, and cross-sectional SEM observation was performed on one of them. Each average c/d of the cathode, the second mixed layer, and the second support measured from the SEM image was 1.5. As the vanishing material, an elliptical resin with R/r=1.5/1 was used on the cathode side in the same manner as in Example 1. Therefore, the voids were unidirectionally contracted, and as a result, the c/d became 1.5. It is thought that since spherical resin with R/r=1 was used as the vanishing material on the anode side, the voids contracted in an anisotropic manner and, as a result, the c/d became 1.

When the warp was evaluated, the warp was less than 1%. It is considered that this was because of the symmetrical structure. Also, no short circuit between electrodes occurred. It is considered that this was because a space was taken from the outer periphery when printing on the cathode side. When performing power generation evaluation, evaluation was performed in a state in which one cell was sandwiched between upper and lower interconnectors. Moreover, there was no current collector between the cell and the interconnectors, and they were connected by laser welding. As a result of power generation evaluation, each resistance value was separated by impedance measurement, and the ohmic resistance of this cell was 0.3 Ω·cm² and the reaction resistance was 0.7 Ω·cm². The effective power generation area utilization rate of the cell was (96×96)/(100×100)=92%. The larger the effective area was, the higher the current that can be extracted from the cell was. Therefore, the current that flowed when the terminal voltage was 0.9V was 18.3 A.

(Example 3) In order to adjust the c/d, as the vanishing material used in the printing slurry, a circular resin was used instead of an elliptical resin. Other conditions were the same as in Example 2. A plurality of cells were produced, and cross-sectional SEM observation was performed on one of them. Each average c/d of the cathode, the second mixed layer, and the second support measured from the SEM image was 1. In order to control the c/d, the vanishing material used in Example 3 was changed to a spherical resin with R/r=1. It is considered that R/r=c/d=1 because the voids generated by the vanishing material shrunk anisotropically as sintering progressed. Similarly, in the anode side, the vanishing material was also changed to a spherical resin with R/r=1. It is considered that R/r=c/d=1 because the voids generated by the vanishing material shrunk anisotropically as sintering progressed.

When the warp was evaluated, the warp was less than 1%. It is considered that this was because of the symmetrical structure. Also, no short circuit between electrodes occurred. It is considered that this was because a space was taken from the outer periphery when printing on the cathode side. When performing power generation evaluation, evaluation was performed in a state in which one cell was sandwiched between upper and lower interconnectors. Moreover, there was no current collector between the cell and the interconnectors, and they were connected by laser welding. As a result of power generation evaluation, each resistance value was separated by impedance measurement, and the ohmic resistance of this cell was 0.3 Ω·cm² and the reaction resistance was 0.7 Ω·cm². The effective power generation area utilization rate of the cell is (96×96)/(100×100)=92%. Therefore, the larger the effective area was, the higher the current that can be extracted from the cell was. Therefore, the current that flowed when the terminal voltage was 0.9V was 18.3 A.

(Example 4) A half cell was fired in which the support green sheet, the mixed layer green sheet, the anode green sheet, and the electrolyte green sheet were stacked in this order. On the electrolyte layer of the fired half-cell, the material for cathode was printed and dried, the material for mixed layer was printed and dried, and the material for support was printed and dried. After that, a sintering process was performed to produce a single cell having a symmetrical structure. The size of the vanishing material used in the printing slurry was adjusted to adjust the c/d. The size of the ellipse in the length direction was R. The size of the ellipse in the short direction was r. The resin of R/r=2/1 was used. Other conditions were the same as in Example 1. A plurality of cells were produced, and cross-sectional SEM observation was performed on one of them. Each average c/d of the cathode, the second mixed layer, and the second support measured from the SEM image was 2. Since the spherical resin with R/r=1 was used as the vanishing material on the anode side, it is considered that the voids contracted in an anisotropic manner, and as a result, the c/d became 1.

When the warp was evaluated, the warp was less than 1%. It is considered that this was because of the symmetrical structure. Also, no short circuit between electrodes occurred. It is considered that this was because a space was taken from the outer periphery when printing on the cathode side. When performing power generation evaluation, evaluation was performed in a state in which one cell was sandwiched between upper and lower interconnectors. Moreover, there was no current collector between the cell and the interconnectors, and they were connected by laser welding. As a result of power generation evaluation, each resistance value was separated by impedance measurement, and the ohmic resistance of this cell was 0.3 Ω·cm² and the reaction resistance was 0.7 Ω·cm². The effective power generation area utilization rate of the cell is (96×96)/(100×100)=92%. The larger the effective area was, the higher the current that can be extracted from the cell was. Therefore, the current that flowed when the terminal voltage was 0.9V was 18.3 A.

(Example 5) In order to adjust the c/d, the dimensions of the vanishing material used in the printing slurry were adjusted. The size of the ellipse in the length direction was R. The size of the ellipse in the short direction was r. The resin of R/r=2.5/1 was used. A plurality of cells were produced, and cross-sectional SEM observation was performed on one of them. Each average c/d of the cathode, the second mixed layer, and the second support measured from the SEM image was 2.5. Since the spherical resin with R/r=1 was used as the vanishing material on the anode side, it is considered that the voids contracted in an anisotropic manner and, as a result, the c/d became 1. Other conditions were the same as in Example 4.

When the warp was evaluated, the warp was less than 1%. It is considered that this was because of the symmetrical structure. Also, no short circuit between electrodes occurred. It is believed that this was because a space was taken from the outer periphery when printing on the cathode side. When performing power generation evaluation, evaluation was performed in a state in which one cell was sandwiched between upper and lower interconnectors. Moreover, there was no current collector between the cell and the interconnectors, and they were connected by laser welding. As a result of power generation evaluation, each resistance value was separated by impedance measurement, and the ohmic resistance of this cell was 0.3 Ω·cm² and the reaction resistance was 0.7 Ω·cm². The effective power generation area utilization rate of the cell is (96×96)/(100×100)=92%. Therefore, the larger the effective area was, the higher the current that can be extracted from the cell was. Therefore, the current that flowed when the terminal voltage was 0.9V was 18.3 A.

(Comparative example 1) No space was taken from the outer periphery when printing the cathode side. That is, the opposite side was printed with an area of 100 mm×100 mm. Other conditions were the same as in Example 1. After firing, the support layers on both sides were connected with a tester, and as a result of measurement, it was confirmed that the electrodes were short-circuited. In addition, as a result of examining the outer periphery of the cell with a microscope, it was observed that the metal parts on both sides were connected, suggesting that the metal parts were connected during the sintering process. Such cells could not be evaluated for power generation. A plurality of cells were produced, and cross-sectional SEM observation was performed on one of them. Each average c/d of the cathode, the second mixed layer, and the second support measured from the SEM image was 1.5. It is considered that since the spherical resin with R/r=1 was used as the vanishing material on the anode side, the voids contracted in an anisotropic manner and, as a result, the c/d became 1.

(Comparative example 2) A half cell was fired in which the support green sheet, the mixed layer green sheet, the anode green sheet, and the electrolyte green sheet were stacked in this order. On the electrolyte layer of the fired half-cell, the material for cathode was printed and dried, the material for mixed layer was printed and dried, and the material for support was printed and dried. After that, a sintering process was performed to produce a single cell having a symmetrical structure. The size of the single cell was 100 mm×100 mm, and no sealing material was applied to the periphery of the cell. The anode side was impregnated with Ni and GDC for an area of 96 mm×96 mm. Next, on the cathode side, LSM was printed on an area of 96 mm×96 mm, and sintered at a temperature of 900° C. or less to suppress oxidation of the metal support. The structure of the single cell was asymmetric and the warpage was evaluated to be 4%. When performing power generation evaluation, evaluation was performed in a state in which one cell was sandwiched between upper and lower interconnectors. Also, on the anode side, there was no current collector between the cell and the interconnectors, and they were connected by laser welding. The cathode side was made of ceramic material only, and it was impossible to connect the cathode to an interconnector by welding. This is probably because the warp was large. Therefore, the current collector was provided between the cell and the interconnector, and the evaluation was performed in a sandwiched state. As a result of power generation evaluation, each resistance value by impedance measurement was separated, and the ohmic resistance of this cell was 0.7 Ω·cm² and the reaction resistance was 0.7 Ω·cm². Compared to Examples 1 to 4, the cell could not be fixed by welding on the cathode side, and when the current collector was sandwiched, the contact became poor and the ohmic resistance increased significantly. The effective power generation area utilization rate of the cell was (96×96)/(100×100)=92%. In addition, the current flowed when the terminal voltage was 0.9 V was 13.2 A. Compared with Example 2, the effective power generation area was the same, but the ohmic resistance was increased, so when the terminal voltage was the same, the electric current that can be taken out by power generation was greatly reduced.

Tables 1 and 2 show the results of Examples 1 to 5 and Comparative Examples 1 and 2.

TABLE 1

| | | | | EFFECTIVE |
|---|---|---|---|---|
| | | | | POWER |
| | | PAINT | PAINT | GENERATION |
| | | AREA OF | AREA OF | AREA |
| | MANUFACTURING | ANODE | CATHODE | UTILIZATION |
| | METHOD | CATALYST | CATALYST | RATE |
| EXAMPLE 1 | STACKING (UNTIL | 98 × 98 mm | 98 × 98 mm | 96% |
| | ELECTROLYTE) | | | |
| | → CATHODE SIDE PRINT | | | |
| | → FIRING | | | |
| EXAMPLE 2 | STACKING (UNTIL | 96 × 96 mm | 96 × 96 mm | 92% |
| | ELECTROLYTE) | | | |
| | → CATHODE SIDE PRINT | | | |
| | → FIRING | | | |
| EXAMPLE 3 | STACKING (UNTIL | 96 × 96 mm | 96 × 96 mm | 92% |
| | ELECTROLYTE) | | | |
| | → CATHODE SIDE PRINT | | | |
| | → FIRING | | | |
| EXAMPLE 4 | STACKING (UNTIL | 96 × 96 mm | 96 × 96 mm | 92% |
| | ELECTROLYTE) | | | |
| | → CATHODE SIDE PRINT | | | |
| | → FIRING | | | |
| EXAMPLE 5 | STACKING (UNTIL | 96 × 96 mm | 96 × 96 mm | 92% |
| | ELECTROLYTE) | | | |
| | → CATHODE SIDE PRINT | | | |
| | → FIRING | | | |
| COMPARATIVE | STACKING | — | — | — |
| EXAMPLE 1 | → CO-FIRING | | | |
| COMPARATIVE | HALF CELL | 96 × 96 mm | LSM PRINT | 92% |
| EXAMPLE 2 | → CATHODE | | (96 × 96 mm) | |

TABLE 2

| | | WELDING | | | | | |
|---|---|---|---|---|---|---|---|
| | | OF | | | OHMIC | REACTION | CURRENT |
| | | INTER- | WARPAGE | ELECTRIC | RESISTANCE | RESISTANCE | (A) |
| | c/d | CONNETOR | AMOUNT | COLLECTOR | (Ω · cm²) | (Ω · cm²) | @0.9 V |
| EXAMPLE 1 | 1.5 | POSSIBLE | >1% | NONE | 0.3 | 0.7 | 19.1 |
| EXAMPLE 2 | 1.5 | POSSIBLE | >1% | NONE | 0.3 | 0.7 | 18.3 |
| EXAMPLE 3 | 1 | POSSIBLE | >1% | NONE | 0.3 | 0.7 | 18.3 |
| EXAMPLE 4 | 2 | POSSIBLE | >1% | NONE | 0.3 | 0.7 | 18.3 |
| EXAMPLE 5 | 2.5 | POSSIBLE | >1% | NONE | 0.3 | 0.7 | 18.3 |
| COMPARATIVE | 1.5 | — | >1% | — | — | — | — |
| EXAMPLE 1 | | | | | | | |
| COMPARATIVE | — | POSSIBLE | 4% | ONLY ON | 0.7 | 0.7 | 13.2 |
| EXAMPLE 2 | | ON ANODE | | CATHODE | | | |
| | | SIDE | | SIDE | | | |

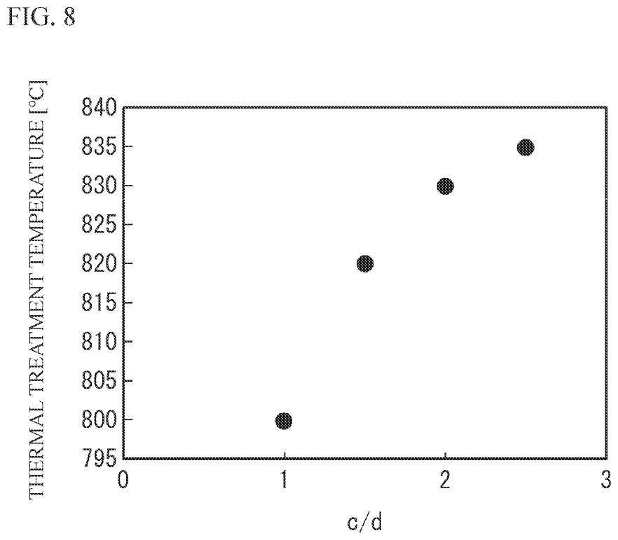

(Evaluation of c/d) In order to evaluate the crackability of the electrolyte, the single cells of Examples 2 to 5 were subjected to thermal treatment at a temperature of 800° C. or higher, and when the electrolyte cracked after the thermal treatment, it is recognized that gas leak measurement revealed. FIG. 8 shows the relationship between the thermal treatment temperature at which gas leakage was detected and the c/d value. It was found that the higher the c/d was, the higher the tolerable thermal treatment temperature was. That is, it can be seen that the larger c/d was, the more difficult the electrolyte was to crack.

Although the embodiments of the present invention have been described in detail, it is to be understood that the various change, substitutions, and alterations could be made hereto without departing from the spirit and scope of the invention.

1. A solid oxide fuel cell characterized by comprising:
a solid electrolyte layer including a solid oxide having oxide ion conductivity;
an anode that is provided on a first face of the solid electrolyte layer, includes a porous body including an electron conductive ceramics and an oxide ion conductive ceramics, and includes an anode catalyst in the porous body;
a first mixed layer that is provided on a face of the anode opposite to the solid electrolyte layer and has a structure in which a metallic material and a ceramics material are mixed;
a first support that is provided on a face of the first mixed layer opposite to the solid electrolyte layer and has a main component of metal;
a cathode that is provided on a second face of the solid electrolyte layer, includes a porous body including an electron conductive ceramics and an oxide ion conductive ceramics, and includes a cathode catalyst in the porous body;
a second mixed layer that is provided on a face of the cathode opposite to the solid electrolyte layer and has a structure in which a metallic material and a ceramics material are mixed;
a second support that is provided on a face of the second mixed layer opposite to the solid electrolyte layer and has a main component of metal,
wherein one of an outer periphery of the anode, the first mixed layer and the first support and an outer periphery of the cathode, the second mixed layer and the second support is positioned inwardly with respect to other.

2. The solid oxide fuel cell as claimed in claim 1 characterized in that:
one of the outer periphery of the anode, the first mixed layer and the first support and the outer periphery of the cathode, the second mixed layer and the second support is positioned inwardly with respect to other by 1 mm or more.

3. The solid oxide fuel cell as claimed in claim 1 or 2 characterized in that:
the solid oxide fuel cell has a substantially rectangular shape in a plan view; and
a/b is 1/10 or less when a length from the outer periphery of the anode, the first mixed layer, and the first support to the outer periphery of the cathode, the second mixed layer, and the second support is “a” and a length of one side of the solid oxide fuel cell is “b”.

4. The solid oxide fuel cell as claimed in any of claims 1 to 3 characterized in that:
the outer periphery of the cathode, the second mixed layer and the second support is positioned inwardly with respect to the outer periphery of the anode, the first mixed layer and the first support.

5. The solid oxide fuel cell as claimed in any of claims 1 to 4 characterized in that:
a warpage amount of the solid oxide fuel cell is less than 4%.

6. The solid oxide fuel cell as claimed in any of claims 1 to 5 characterized in that:
an average of each c/d value of voids of the cathode is larger than an average of each c/d value of voids of the anode when a length of a void of each layer in an extension direction thereof in a cross section including a stacking direction is “c”, and a height of the void in the stacking direction is “d”;
an average of each c/d value of voids of the second mixed layer is larger than an average of each c/d value of voids of the first mixed layer; and
an average of each c/d value of voids of the second support is larger than an average of each c/d value of voids of the first support.

7. The solid oxide fuel cell as claimed in any of claims 1 to 6 characterized in that:
an average of each of c/d value of the cathode, the second mixed layer and the second support is more than 1 and less than 3.

8. The solid oxide fuel cell as claimed in any of claims 1 to 7 characterized in that:
the anode catalyst is Ni and GDC; and
the cathode catalyst includes at least one of PrOₓ, LSM, LSC, and GDC.

9. The solid oxide fuel cell as claimed in any of claims 1 to 8 characterized in that:
an average grain size of the anode catalyst and the cathode catalyst is 100 nm or less.

10. The solid oxide fuel cell as claimed in any of claims 1 to 9 characterized in that:
among a porosity of the first support, a porosity of the first mixed layer, and a porosity of the anode, there is a relationship of the first support>the first mixed layer>the anode; and
among a porosity of the second support, a porosity of the second mixed layer, and a porosity of the cathode, there is a relationship of the second support>the second mixed layer>the cathode.

11. The solid oxide fuel cell as claimed in any of claims 1 to 10 characterized in that:
among a thickness of the first support, a thickness of the first mixed layer, and a thickness of the anode, there is a relationship of the first support>the first mixed layer>the anode; and
among a thickness of the second support, a thickness of the second mixed layer, and a thickness of the cathode, there is a relationship of the second support >the second mixed layer>the cathode.

12. A manufacturing method of a solid oxide fuel cell characterized by comprising:
preparing a multilayer structure in which a support green sheet containing a metal powder, a mixed layer green sheet containing a ceramics material powder and a metallic material powder, an electrode green sheet containing an electron conductive ceramics material powder and an oxide ion conductive ceramics material powder, and an electrolyte green sheet containing a solid oxide material powder having oxide ion conductivity; and
printing a slurry containing an electron conductive ceramics material powder and an oxide ion conductive ceramics material powder, a slurry containing a ceramics material powder and a metallic material powder, and a slurry containing a metal powder inwardly of the outer periphery of the electrolyte green sheet, and after that, firing the multilayer structure.
